(19) United States
(12) Patent Application Publication
(10) Pub. No.: US 2015/0046759 A1
(43) Pub. Date: Feb. 12, 2015

(54) SEMICONDUCTOR INTEGRATED CIRCUIT DEVICE

(71) Applicant: Renesas Electronics Corporation, Kawasaki-shi (JP)

(72) Inventors: HIROMICHI YAMADA, Tokyo (JP); NOBUYASU KANEKAWA, Tokyo (JP); TSUTOMU YAMADA, Tokyo (JP); KESAMI HAGIWARA, Kanagawa (JP); YUICHI ISHIGURO, Kanagawa (JP); TAKASHI YASUMASU, Kanagawa (JP); KAZUYOSHI FUKUDA, Kanagawa (JP); YOSHIYUKI NAKADA, Kanagawa (JP)

(73) Assignee: RENESAS ELECTRONICS CORPORATION

(21) Appl. No.: 14/455,880

(22) Filed: Aug. 9, 2014

(30) Foreign Application Priority Data
Aug. 9, 2013 (JP) 2013-165781

(51) Int. Cl. G06F 11/16

(52) U.S. Cl. CPC G06F 11/1612
USPC 714/54

(57) ABSTRACT

A micro controller with fault detection function is provided, in which duplex processing by a program is realized without complicating the program. Peripheral circuits are provided with registers and execute processing based on a command. A central processing unit executes twice processing by the same program that accesses the register. A duplex access control circuit is configured with a peripheral bus access unit, a buffer, and a comparator unit. The peripheral bus access unit controls the access to the register by the central processing unit in the first program execution. The buffer stores the access information to the register in the first program execution. The comparator unit compares the access information in the second program execution with the access information stored in the access information storage unit. In the case of disagreement, an error signal is outputted to the central processing unit.

### CROSS-REFERENCE TO RELATED APPLICATIONS

The disclosure of Japanese Patent Application No. 2013-165781 filed on Aug. 9, 2013 including the specification, drawings and abstract is incorporated herein by reference in its entirety.

### BACKGROUND

The present invention relates to a semiconductor integrated circuit device, and in particular, relates to technology which is effective in a micro controller provided with fault detection function.

As one of semiconductor integrated circuit devices, a micro controller is known widely, for example. The micro controller is built in such devices an home electric appliances, AV equipment, a mobile-phone, an automobile, on an industrial machine, and controls each device by executing processing according to a program stored in an internal memory.

In the device represented by an automobile, etc., a fault of a control apparatus stay lead to an accident. Therefore, high reliability is demanded for components including a micro controller, and even when a fault occurs, the device is designed to detect the fault and to activate safety function so that the device may not fall into a dangerous state.

The micro controller not only needs to make a diagnosis of a sensor and an actuator and to detect a fault of these devices, but needs to detect a fault of the micro controller itself. There are various methods in the fault detection of a micro controller and CPU duplexing is known as one of the typical technologies (refer to Patent Literature 1).

The CPU duplexing is the technology of detecting a fault, by duplexing the processing with two central processing units or CPUs provided as functional blocks having the same function, and comparing the output signals from the two CPUs.

### PATENT LITERATURE

(Patent Literature 1) Japanese Unexamined Patent Application Publication No. Hei 8 (1996)-171581

### SUMMARY

However, the present inventors have found that the fault detection technology described above has the following problems.

In the CPU duplexing technology, it is necessary to add two CPUs and a comparator circuit which compares signals outputted from two CPUs. Therefore, there arises the problem that the circuit area of the CPU becomes more than double, accompanied by increase in chip cost and power consumption.

Accordingly, the present inventors have examined the technology in which a program is doubly executed by a CPU which is not duplexed, such as a single-core CPU and a dual-core CPU, and the results are compared.

In the first execution and the second execution of a program, the processing is executed independently by setting the memory access by a CPU to different addresses, through the address conversion by use of the function of a MMU (Memory Management Unit), for example.

On the other hand, as for the access to a register of a peripheral circuit performed by the CPU, in the first execution, the access is performed and the address as the access information is registered to a memory in the case of write, write data is registered at the memory), and in the second execution, the access is not performed and comparison is made with the address as the access information registered in the first execution (in the case of write, the comparison is made also for the write data).

When the comparison result shows non-coincidence, it means that the first execution and the second execution do not coincide in the duplex processing of the program; accordingly, it can be considered that the CPU is out of order.

However, in the present processing, contents of processing are partly different between the first execution and the second execution; accordingly, the program becomes complicated. Furthermore, when a dual-core CPU is employed, it is incomprehensible which core performs processing first. Therefore, it is necessary to confirm whether the processing is anterior or posterior, before the access to the register of the peripheral circuit is made; accordingly, the program becomes still more complicated.

Therefore, the examined technology which compares the duplex processing of a program can reduce the chip cost and power consumption, but on the other hand, the program becomes complicated and the development man-hour increases, generating another problem.

The other objects and new features of the present invention will become clear from the description of the present specification and the accompanying drawings.

A semiconductor integrated circuit device according to one embodiment is configured with a peripheral circuit, a central processing unit, and an access control circuit. The peripheral circuit is provided with a register and executes processing on the basis of a command inputted. The central processing unit executes duplex processing in which processing by the same program accessing the register is executed twice. The access control circuit performs access control when the central processing unit accesses the peripheral circuit.

The access control circuit is configured with a bus access unit, an access information storage unit, and a comparator unit. The bus access unit controls access to the register by the central processing unit in the first execution of the program by the central processing unit.

The access information storage unit stores first access information which is the information at the time of the central processing unit accessing the register in the first execution of the program by the central processing unit.

The comparator unit compares the first access information stored in the access information storage unit, with the second access information which is the information at the time of the central processing unit accessing the register in the second execution of the program by the central processing unit, and outputs an error signal to the central processing unit when the first access information disagrees with the second access information.

According to the one embodiment, it is possible to reduce the development man-hour of the program.

### BRIEF DESCRIPTION OF THE DRAWINGS

FIG. 1 is a block diagram illustrating an example of a configuration of a micro controller according to Embodiment 1;

FIG. 2 is an explanatory diagram illustrating an example of a data configuration of a buffer provided in a duplex access control circuit illustrated in FIG. 1;

FIG. 3 is a flow chart illustrating an example of processing of operation in the duplex access control circuit provided in the micro controller illustrated in FIG. 1;

FIG. 4 is a timing chart illustrating an example at the time of a read access to a register provided in a peripheral circuit is the first execution of a program;

FIG. 5 is a timing chart illustrating an example at the time of a read access to the register provided in the peripheral circuit in the second execution of the program;

FIG. 6 is a timing chart illustrating an example at the time of a write access to the register provided in the peripheral circuit in the first execution of the program;

FIG. 7 is a timing chart illustrating an example at the time of a write access to the register provided in the peripheral circuit in the second execution of the program;

FIG. 8 is a block diagram illustrating an example of a configuration of a micro controller according to Embodiment 2;

FIG. 9 is an explanatory diagram illustrating an example of a data structure of a buffer provided in the micro controller illustrated in FIG. 8;

FIG. 10 is a timing chart illustrating an example at the time of a read access to a register provided in a peripheral circuit in the first execution of a program;

FIG. 11 is a timing chart illustrating an example at the time of a read access to the register provided in the peripheral circuit in the second execution of the program;

FIG. 12 is a timing chart illustrating an example at the time of a write access to the register provided in the peripheral circuit in the first execution of the program;

FIG. 13 is a timing chart illustrating an example at the time of a write access to the register provided in the peripheral circuit in the second execution of the program;

FIG. 14 is a block diagram illustrating an example of a configuration of a micro controller according to Embodiment 3;

FIG. 15 is a block diagram illustrating an example of a configuration of a micro controller according to Embodiment 4;

FIG. 16 is a timing chart illustrating an example at the time of an anterior read access to a register provided in a peripheral circuit in the parallel processing of a program;

FIG. 17 is a timing chart illustrating an example at the time of a posterior read access to the register provided in the peripheral circuit in the parallel processing of the program;

FIG. 18 is a timing chart illustrating an example at the time of an anterior write access to the register provided in the peripheral circuit in the parallel processing of the program;

FIG. 19 is a timing chart illustrating an example at the time of a posterior write access to the register provided in the peripheral circuit in the parallel processing of the program; and

FIG. 20 is an explanatory diagram illustrating an example of a system using a micro controller according to Embodiment 5.

### DETAILED DESCRIPTION

In the following embodiments, when there is the necessity for convenience, the explanation will be divided into plural sections or plural embodiments. However, unless otherwise specified, they are not irrelevant with each other but they have a relationship that one is a modified example, details, and, supplementary explanation of a part or all of the other.

In the following embodiments, when the number of elements, etc. (including the number, a numeric value, quantity, a range, etc.) is referred to, the number of elements may be not restricted to a specific number but may be more than or less than the specific number, except for the case where it is specified in particular or clearly restricted to the specific number in principle.

Furthermore, it is needless to say that, in the following embodiments, a component (including an element step, etc.) referred to is not always essential, except for the case where it is specified in particular or clearly considered to be essential in principle.

Similarly, in the following embodiments, when referring to the shape, positional relationship, etc. of a component, etc, what is analogous or similar substantially to the shape, positional relationship, etc. shall be included, except for the case where it is specified in particular or clearly not considered to be so in principle. The same applies to the number of elements and a range described above.

In the entire diagrams for explaining the embodiments of the present invention, the same symbol is attached to the same component as a general rule, and the repeated explanation thereof is omitted. Even if the drawing is a plan view, hatching may be attached in order to make the drawing easier to see.

### Embodiment 1

### A Configuration Example of a Micro Controller

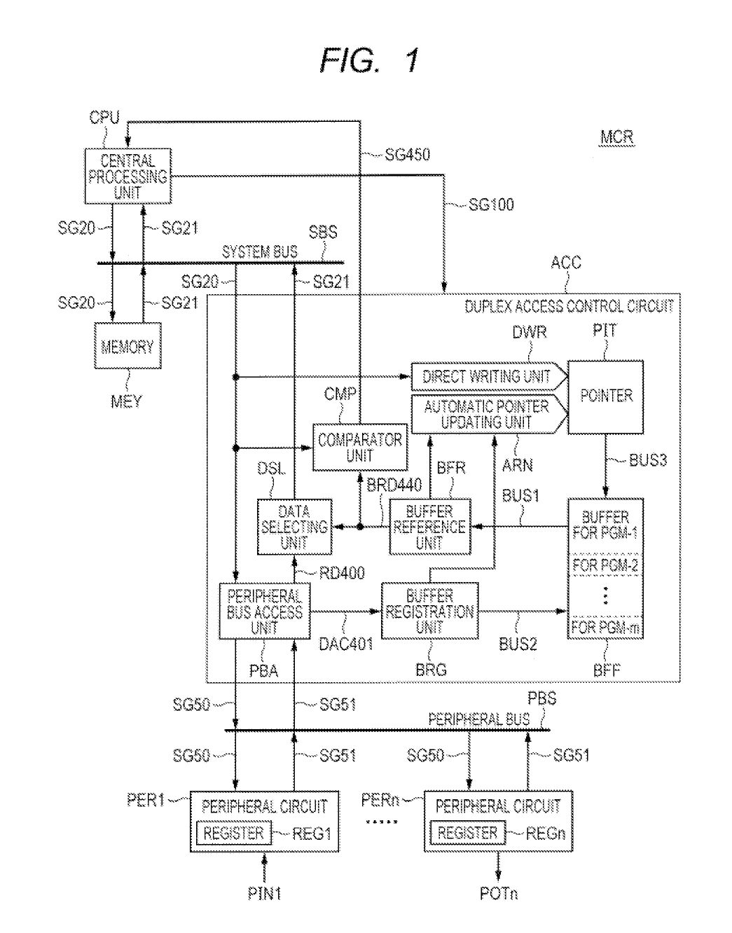

FIG. 1 is a block diagram illustrating an example of a configuration of a micro controller according to Embodiment 1.

A micro controller MCR is a single core CPU, and executes duplex access control in which the micro controller MCR executes a program repeatedly and performs access control to a peripheral circuit register and comparison of the access information.

The micro controller MCR is configured with a central processing unit CPU, a memory MEY, a duplex access control circuit ACC, and plural peripheral circuits PER1-PERn, as illustrated in FIG. 1. Here, n is the number of peripheral circuits. The micro controller MCR is a semiconductor integrated circuit device formed over one semiconductor substrate integrating the elements described above. The micro controller MCR is packaged by a QFP (Quad Flat Package), a BGA (Ball Grid Array) package, etc.

The central processing unit CPU is coupled to the memory MEY and the system bus SBS. The central processing unit CPU is also coupled to the duplex access control circuit ACC as an access control circuit via the system bus SBS.

Signals transferred through the system bus SBS include a signal SG20 outputted by the central processing unit CPU and inputted to the memory MEY or the duplex access control circuit ACC, and a signal SG21 outputted by the memory MEY or the duplex access control circuit ACC and inputted to the central processing unit CPU.

The signal SG20 is access information including a command, an address, and write data. The command includes an NOP (No Operation) which means doing nothing, read, write, and data size, for example. The signal SG21 includes a ready signal which indicates the completion of read data and read preparation.

The duplex access control circuit ACC is coupled to the peripheral circuits PER1-PERn via a peripheral bus PBS as the first bus. Signals transferred through the peripheral bus PBS include a signal SG50 outputted by the duplex access control circuit ACC and inputted to the peripheral circuits PER1-PERn, and a signal SG51 outputted by the peripheral circuits PER1-PERn and inputted to the duplex access control circuit ACC.

The signal SG50 includes a command, an address, and write data. The command includes an NOP, read, write, data size, for example. The signal SG51 read from the peripheral circuits PER1-PERn includes read data and a ready signal.

The central processing unit CPU executes an instruction and perform processing such as operation, data transfer, etc. The memory MEY stores an instruction which the central processing unit CPU executes and data which the central processing unit CPU processes. The memory MEY is configured with a nonvolatile semiconductor or memory exemplified by a flash memory, and a volatile semiconductor memory exemplified by a static random access memory.

The duplex access control circuit ACC is configured with a peripheral bus access unit PBA, a data selecting unit DSL, a buffer BFF, a buffer registration unit BRG, a buffer reference unit BRF, a comparator unit CMP, a pointer PIT, a direct writing unit DWR, and an automatic pointer updating unit ARN.

The duplex access control circuit ACC has fault detection function to the central processing unit CPU. When the central processing unit CPU accesses respectively built-in registers REG1-REGn of the peripheral circuits PER1-PERn, the duplex access control circuit ACC accesses the registers REG1-REGn of the peripheral circuits PER1-PERn in the first execution of a program.

Subsequently, the central processing unit CPU registers the access information in the buffer BFF serving as an access information storage unit. In the second execution performing the same processing as the first execution, the central processing unit CPU does not access the registers REG1-REGn, instead the comparator unit CMP compares the access information with the first information which has been registered in the buffer BFF. By the above procedure, a fault is detected. Here, the buffer BFF is configured with a volatile memory such as an SRAM (Static Random Access Memory), for example.

The peripheral circuit PER1 is an A/D (Analog/Digital) converter, for example. The A/D converter has function to read an analog signal from an input terminal PIN1, to convert it into a digital signal, and to store the digital signal to the register REG1.

The peripheral circuit PERn is a timer, for example. The timer generates a pulse with the cycle and width which the central processing unit CPU has set in the register REGn, and outputs the pulse from an output terminal POTn.

### A Configuration Example of the Duplex Access Control Circuit

Next, the duplex access control circuit ACC is explained in detail.

A signal SG100 outputted by the central processing unit CPU and inputted to the duplex access control circuit ACC is the signal which indicates the count of duplex processing. The duplex processing executes the same program twice, and the signal SG100 is a duplex processing count signal indicative of the count of the duplex processing which indicates whether the program execution is the first execution or the second execution that performs the same processing as the first execution, and serves as a processing count determination signal.

The central processing unit CPU is provided with a register indicating whether the program execution in the duplex processing is the first execution or the second execution which performs the same processing as the first execution. The central processing unit CPU sets up the value of the register before the start of the program execution.

A signal SG450 outputted by the duplex access control circuit ACC and inputted to the central processing unit CPU is a comparison result signal. When the signal SG450 reflecting the comparison result indicates non-coincidence or an error, it means that the first execution and the second execution in the duplex processing of a program do not coincide; therefore, it is possible to consider that the central processing unit CPU is out of order. In this way, the duplex access control circuit ACC has the fault detection function to detect that the central processing unit CPU is out of order.

When the signal SG450 reflecting the comparison result indicates non-coincidence, an exception handling program is executed to perform processing such as generating an interrupt to the central processing unit CPU to perform an error processing, or resetting the micro controller MCR.

In the duplex access control circuit ACC, the peripheral bus access unit PBA as the bus access unit monitors the signal SG20 of the system bus SBS as the second bus, and accesses the peripheral bus PBS. When the signal SG20 indicates a read or a write, and the signal SG100 expressing the count of the duplex processing indicates the first execution, the peripheral bus access unit PBA accesses the peripheral bus PBS.

When the signal SG20 indicates a read, the read data a RD400 is selected by the data selecting unit DSL, outputted to the system bus SBS, and fetched to the central processing unit CPU. The peripheral bus access unit PBA outputs access information DAC401 including a command, an address, and data, and the buffer registration unit BRG writes it in the buffer BFF. Here, the access information DAC401 is the read data in the case of a read, or the write data in the case of a write.

The buffer BFF has the divided buffer areas for use in each program which is stored in the memory MEY, such as, an area for the program PGM-1, an area for the program PGM-2, . . . , and an area for the program PGM-m.

The buffer BFF is coupled to the buffer reference unit BRF via a dedicated bus BUS1, and to the buffer registration unit BRG via a dedicated bus BUS2, and also coupled to the pointer PIT via a dedicated bus BUS3. With the present configuration, it is possible to improve the speed of write, reference, etc. of the access information to the buffer BFF.

When the signal SG20 is a read or a write and the signal SG100 expressing the count of the duplex processing indicates the second execution, the peripheral bus access unit PBA does not access the peripheral bus PBS. The buffer reference unit BRF reads the access information registered in the buffer BFF in the first execution. In the case of a read, read data is selected by the data selecting unit DSL, output ted to the system bus SBS, and fetched to the central processing unit CPU.

The comparator unit CMP compares the command and address of the signal SG20 with the buffer reference data BRD440 read by the buffer reference unit BRF. In the case of a write, write data is compared.

The pointer PIT assigns the address at which registration and reference to the buffer BFF are performed. This pointer PIT is configured with a register, etc. provided in the duplex access control circuit ACC, for example. When the central processing unit CPU instructs to the direct writing unit DWR after the processing start of a program, the direct writing unit DWR writes the value of the register directly. The automatic pointer updating unit ARN performs updating of the pointer PIT. The pointer PIT is updated automatically by the automatic pointer updating unit ARN whenever the registration and reference to the buffer BFF are performed.

### An Example of a Data Configuration in the Buffer

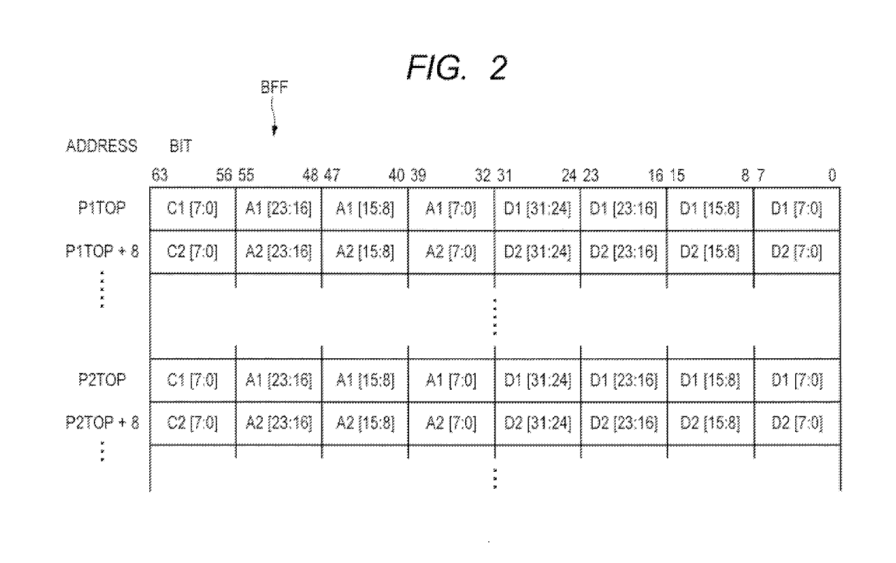

FIG. 2 is an explanatory diagram illustrating an example of a data configuration of the buffer BFF provided in the duplex access control circuit ACC illustrated in FIG. 1.

The buffer BFF is a memory whose data size is 8 bytes. As illustrated in FIG. 2, bits 63-56 are a command, bits 55-32 are an address, and bits 31-0 are data.

The address of the buffer BFF is expressed in units of a byte, and “P1TOP” indicates a starting address for the program PGM-1, and “P1TOP+8” is the second address from the top for the program PGM-1.

“P2TOP” indicates a starting address for the program PGM-2, and “P2TOP+8” is the second address from the top for the program PGM-2. The starting address is determined by the central processing unit CPU writing it in the pointer. The address is incremented by +8 whenever the central processing unit CPU accesses the peripheral circuits PER1-PERn to perform the registration and reference to the buffer BFF.

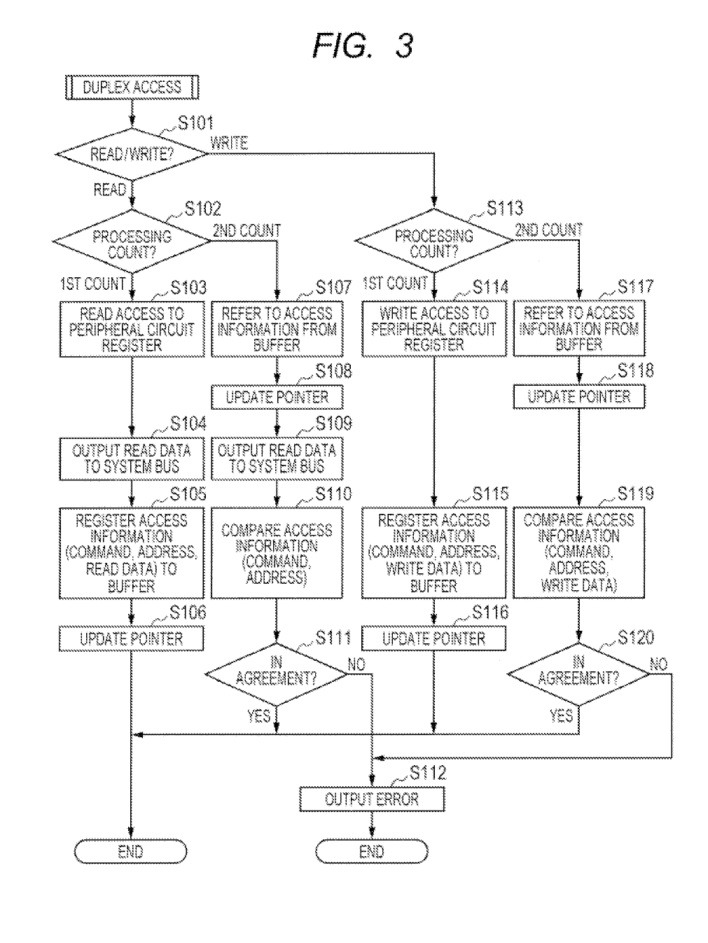

Next, operation of the duplex access control circuit ACC is explained with reference to FIGS. 1 and 3.

### An Example of Processing of the Duplex Access Control Circuit

FIG. 3 is a flow chart illustrating an example of the processing of operation in the duplex access control circuit ACC provided in the micro controller MCR illustrated in FIG. 1.

First, the peripheral bus access unit PBA monitors a command of the system bus (Step S101), and determines whether the command is a read or a write. When it is determined that the command is a read, the count of the duplex processing is confirmed in terms of the signal SG100 (Step S102).

When it is determined that it is the first execution of a program, in the first read of the duplex processing, the peripheral bus access unit PBA performs read access to one of the registers REG1-REGn (Step S103).

The data selecting unit DSL outputs the signal SG51, which is the read data read from the register, to the system bus SBS (Step S104). The buffer registration unit BRG registers the access information (command, address, read data) as the first access information to the buffer BFF (Step S105), and the automatic pointer updating unit ARN updates the pointer PIT (Step S106). With the above-described procedure, the processing is terminated.

When it is determined that it is the second read of the duplex processing in the processing at Step S102, the buffer reference unit BRF refers to the access information in the buffer BFF (Step S107), and the automatic pointer updating unit ARN updates the pointer PIT (Step S108).

Then, the data selecting unit DSL outputs the read data, which is read from the buffer BFF, to the system bus SBS (Step S109). Next, the command and address as the second access information acquired in the processing at Step S101 are compared with the command and address as the access information acquired in the processing at Step S103 (Step S110).

When they are in agreement (Step S111), the processing is terminated. When they are in disagreement (Step S111), a signal SG450 expressing an error is outputted to the central processing unit CPU (Step S112) and the processing is terminated.

When the peripheral bus access unit PBA determines that the command is a write in the processing at Step S101, the count of the duplex processing is confirmed (Step S113). When it is determined that it is the first write of the duplex processing in the processing at Step S113, the peripheral bus access unit PBA performs write access to one of the peripheral circuit registers REG1-REGn (Step S114).

Then, the buffer registration unit BRG registers the access information having a command, an address, and write data into the buffer BFF (Step S115). The automatic pointer updating unit ARN updates the pointer PIT (Step S116), and the processing is terminated.

When it is determined that it is the second write of the duplex processing in the processing at Step S113, the buffer reference unit BRF refers to the access information in the buffer BFF (Step S117), and the automatic pointer updating unit ARN updates the pointer PIT (Step S118).

Next, the comparator unit CMP compares the access information (command, address, write data) (Step S119). When they are in agreement (Step S120), the processing is terminated. When they are in disagreement (Step S120), a signal SG450 expressing an error is outputted to the central processing unit CPU (Step S112), and the processing is terminated.

### An Example of Timing of the First Read Access

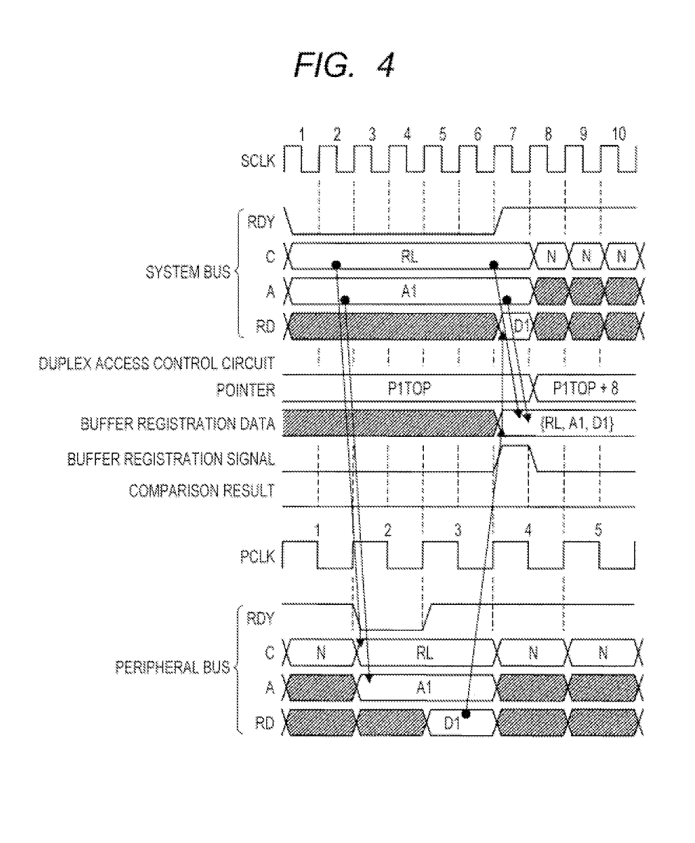

FIG. 4 is a timing chart illustrating an example at the time of a read access to the register provided in the peripheral circuit in the first execution of a program.

FIG. 4 illustrates, beginning at the top, the signal timing in the clock SCLK, the system bus SBS, the duplex access control circuit ACC, the clock PCLK, and the peripheral bus PBS, respectively.

The clock SCLK is a clock of the system bus SBS. In the system bus SBS, a ready signal RDY, a command C, an address A, and read data RD are illustrated, respectively.

In the duplex access control circuit ACC, a pointer PIT, data registered to the buffer BFF, a buffer registration signal, and comparison result are shown, respectively. The clock PCLK is a clock of the peripheral bus PBS. In the peripheral bus PBS, a ready signal RDY, a command C, an address A, and read data RD are shown, respectively.

First, at the cycle of the clock SCLK=1, a command C=RL (read of a long word (32 bits)) and an address A=A1 (address 1) are outputted to the system bus SBS. The duplex access control circuit ACC sets the ready signal RDY of the system bus SBS to RDY=Lo, that is, the duplex access control circuit ACC disenables the system bus SBS and keeps a read access waiting.

At the cycle of the clock PCLK=2, the command C=RL and the address A=A1 are outputted to the peripheral bus PBS. At this cycle, since the read data is not read to the read data RD, the ready signal RDY is set as RDY=Lo.

At the cycle of the clock PCLK=3, D1 (data 1) is read from a register of the peripheral circuit assigned to the address of A1, and the ready signal RDY is set as RDY=Hi, to enable the peripheral bus PBS.

At the cycle of the clock SCLK=7, the duplex access control circuit ACC outputs D1 outputted to the read data RD of the peripheral bus PBS to the read data RD of the system bus SBS, and sets the ready signal RDY as RDY=Hi, to complete the read access.

Assigning the command RL, the address A1, and the read data D1 as the buffer registration data, and setting the buffer registration signal to Hi, the data is written at the buffer address=P1TOP indicated by the pointer PIT, then the pointer PIT is incremented by 8 bytes and updated to the value (P1TOP+8).

Hereafter, when the read access to the register of the peripheral circuit occurs, the access to the peripheral bus PBS and the buffer registration of the access information are performed in the same manner.

### An Example of Timing of the Second Read Access

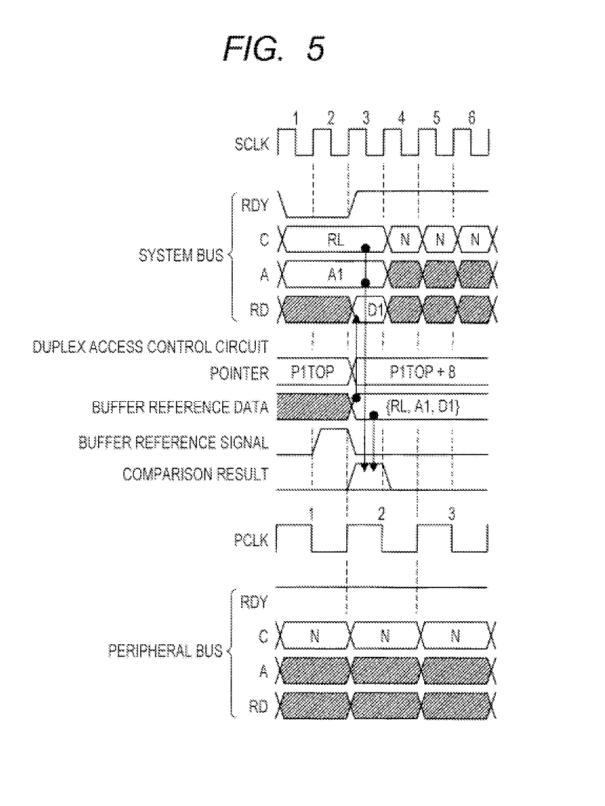

FIG. 5 is a timing chart illustrating an example at the time of a read access to the register provided in the peripheral circuit in the second execution of the program.

As is the case with FIG. 4, FIG. 5 illustrates, beginning at the top, the signal timing in the clock SCLK, the system bus SBS, the duplex access control circuit ACC, the clock PCLK, and the peripheral bus PBS, respectively.

First, at the cycle of the clock SCLK=1, the command C=RL and the address A=A1 are outputted to the system bus SBS. The duplex access control circuit ACC seta the ready signal RDY of the system bus SBS to RDY=Lo (disenabled) and keeps a read access waiting.

At the cycle of the clock SCLK=2, setting the buffer reference signal to Hi, the data is read from the buffer address=P1TOP indicated by the pointer PIT, and at the cycle of the clock SCLK=3, the buffer reference data is set to {RL, A1, D1}.

D1 is outputted to the read data RD of the system bus SBS, and the ready signal RDY is set as RDY=Hi (enabled), to complete the read access. Here, the command C and address A of the system bus SBS are compared with the buffer reference data. In the case of agreement, the signal SG450 expressing the comparison result is set to Lo, and in the case of disagreement, the signal SG450 expressing the comparison result is set to Hi. On the other hand, the pointer PIT is incremented by 8 bytes and updated to the value (P1TOP+8).

Hereafter, when the read access to the register of the peripheral circuit occurs, the buffer reference and comparison of the access information are performed in the same manner.

### An Example of Timing of the First Write Access

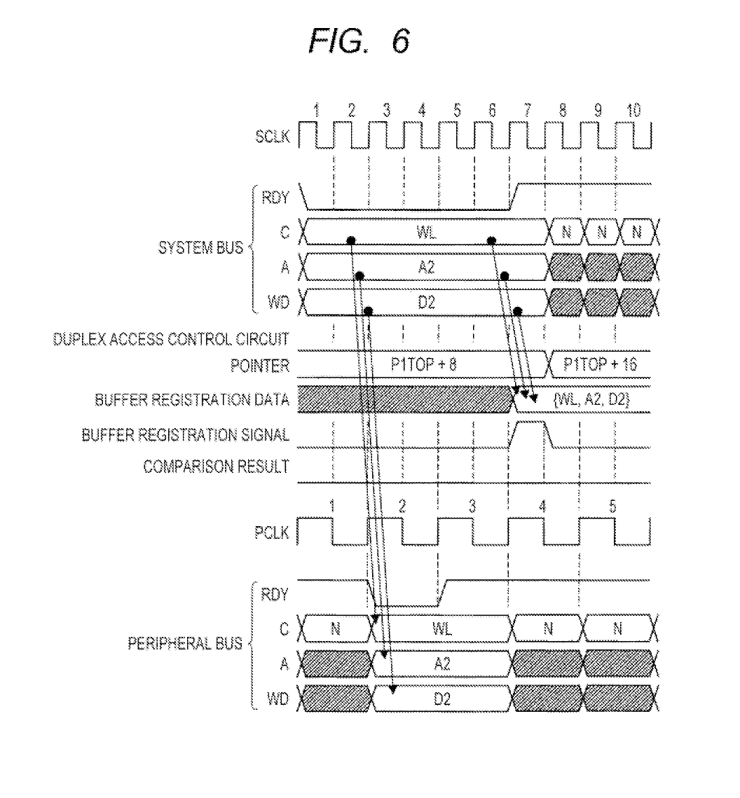

FIG. 6 is a timing chart illustrating an example at the time of a write access to the register provided in the peripheral circuit in the first execution of the program.

As is the case with FIG. 4, FIG. 6 illustrates, beginning at the top, the signal timing in the clock SCLK, the system bus SBS, the duplex access control circuit ACC, the clock PCLK, and the peripheral bus PBS, respectively. What is different from FIG. 4 is the point that the read data RD in the system bus SBS is transcribed as the write data WD.

At the cycle of the clock SCLK=1, a command C=WL (write of a long word (32 bits)) and an address A=A2 (address 2) and write data WD=D2 (data 2) are outputted to the system bus SBS. The duplex access control circuit ACC sets the ready signal RDY of the system bus SBS to RDY=Lo (disenabled) and keeps a write access waiting.

At the cycle of the clock PCLK=2 the command C=WL, the address A=A2, and the write data WD=D2 are outputted to the peripheral bus PBS. At this cycle, since the write access cannot be completed, the ready signal RDY is set as RDY=Lo.

At the cycle of the clock PCLK=3, D2 is written in the register of the peripheral circuit assigned to the address of A2, and the ready signal RDY is set as RDY=Hi.

At the cycle of the clock SCLK=7, the duplex access control circuit ACC sets the ready signal RDY as RDY=Hi, to complete the write access. Assigning the command C=WL, the address A=A2, and the write data WD=D2 as the buffer registration data, and setting the buffer registration signal to Hi, the data is written at the buffer address=P1TOP+8 indicated by the pointer PIT, then the pointer PIT is incremented by 8 bytes and updated to the value (P1TOP+16).

Hereafter, when the write access to the register of the peripheral circuit occurs, the access to the peripheral bus PBS and the buffer registration of the access information are performed in the same manner.

### An Example of Timing of the Second Write Access

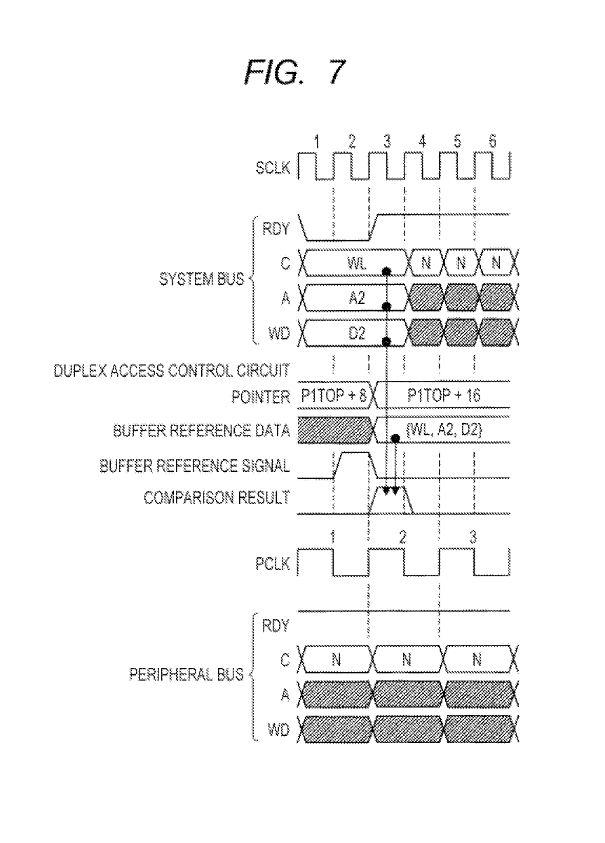

FIG. 7 is a timing chart illustrating an example at the time of a write access to the register provided in the peripheral circuit in the second execution of the program.

As is the case with FIG. 6, FIG. 7 illustrates, beginning at the top, the signal timing in the clock SCLK, the system bus SBS, the duplex access control circuit ACC, the clock PCLK, and the peripheral bus PBS, respectively.

First, at the cycle of the clock SCLK=1, the command C=WL, the address A=A2, and the write data WD=D2 are outputted to the system bus SBS. The duplex access control circuit ACC sets the ready signal RDY of the system bus SBS to RDY=Lo and keeps a write access waiting.

At the cycle of the clock SCLK=2, setting the buffer reference signal to Hi, the data is read from the buffer address=P1TOP+8 indicated by the pointer PIT, and at the cycle of the clock SCLK=3, the buffer reference data is set to {WL, A2, D2}.

The ready signal RDY of the system bus SBS is set as RDY=Hi, to complete the write access. Here, the command C, address A, and write data WD of the system bus SBS are compared with the buffer reference data. In the case of agreement, the signal SG450 expressing the comparison result is set to Lo, and in the case of disagreement, the signal SG450 expressing the comparison result is set to Hi. On the other hand, the pointer PIT is incremented by 8 bytes and updated to the value (P1TOP+16).

Hereafter, when the write access to the register or the peripheral circuit occurs, the buffer reference and comparison of the access information are performed in the same manner.

By the configuration described above, it is possible to detect whether the central processing unit CPU is out of order with the use of the same program. Therefore, it is possible to reduce the increase in the development man-hour of the program, and it is possible to realize the micro controller MCR at low cost.

A central processing unit which will foe employed if CPU duplexing processing is performed becomes unnecessary. Therefore, it is possible to realize reduction in the power consumption and reduction in size of the micro controller MCR.

### Embodiment 2

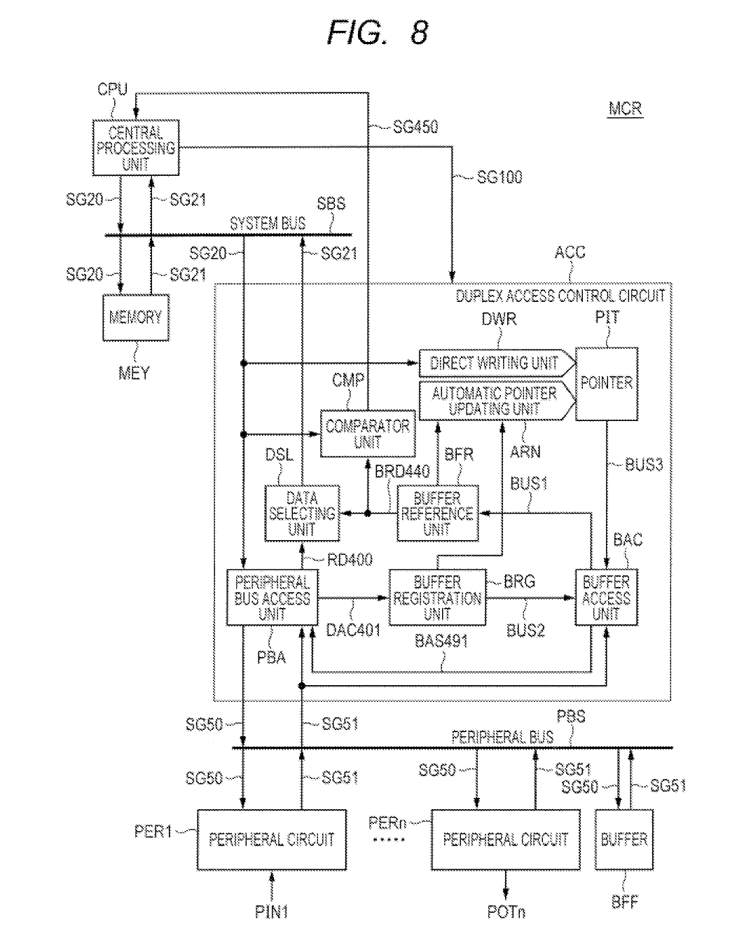

FIG. 8 is a block diagram illustrating an example of a configuration of a micro controller MCR according to Embodiment 2.

### A Configuration Example and an Operation Example of the Micro Controller

In the micro controller MCR illustrated in FIG. 1 according to Embodiment 1, the buffer BFF is provided in the duplex access control circuit ACC. In contrast with this, in the micro controller MCR illustrated in FIG. 8, the buffer BFF is coupled to the peripheral bus PBS and a buffer access unit BAC for accessing the buffer BFF is newly provided in the duplex access control circuit ACC.

In this way, by coupling the buffer BFF to the peripheral bus PBS instead of providing it is the duplex access control circuit ACC, the storage capacity of the buffer BFF can be changed easily.

The peripheral bus access unit PBA monitors a signal SG20 of the system bus SBS and accesses the peripheral bus PBS. When the signal SG20 indicates a read or a write and the signal SG100 indicates the first execution of a program, the peripheral bus access unit PBA accesses the peripheral bus PBS.

When the signal SG20 indicates a read, the read data RD400 is selected by the data selecting unit DSL, outputted to the system bus SBS, and fetched to the central processing unit CPU. The peripheral bus access unit PBA outputs the access information DAC401 (command, address, data (read data in the case of read, and write data in the case of write)), and the buffer registration unit BRG outputs a buffer access request signal to the buffer access unit BAC via the dedicated bus BUS2.

The buffer access unit BAC outputs a buffer access signal BAS491 to the peripheral bus access unit PBA, and the peripheral bus access unit PBA performs a write to the buffer BFF. As is the case with the buffer BFF illustrated in FIG. 1 according to Embodiment 1, the buffer BFF has the divided buffer areas for use in each program, such as, an area for the program PGM-1, an area for the program PGM-2, . . . , and an area for the program PGM-m (not shown).

When the signal SG20 indicates a reader a write, and the signal SG100 expressing the count of the duplex processing indicates the second execution, the peripheral bus PBS is not accessed. In order to read the access information registered in the buffer BFF in the first execution by the buffer reference unit BRF, the buffer access unit BAC outputs the buffer access signal BAS491 to the peripheral bus access unit PBA, and the peripheral bus access unit PBA performs a read from the buffer BFF.

The access information read from the buffer BFF is outputted from the buffer access unit BAC to the buffer reference unit BRF. In the case of a read, read data is selected by the data selecting unit DSL, outputted to the system bus SBS, and fetched to the central processing unit CPU.

The comparator unit CMP compares the signal SG20 as the access information (command, address, write data in the case of a write) with the buffer reference data BRD440 read by the buffer reference unit BRF.

The pointer PIT assigns the address at which registration and reference to the buffer BFF are performed. The pointer PIT is provided as a dedicated register of the duplex access control circuit ACC. When the central processing unit CPU controls the direct writing unit DWR immediately after the processing of a program starts, the value of this register is written directly. The automatic pointer updating unit ARN updates the pointer PIT automatically, whenever registration and reference are performed to the buffer BFF.

### An Example of a Data Configuration of the Buffer

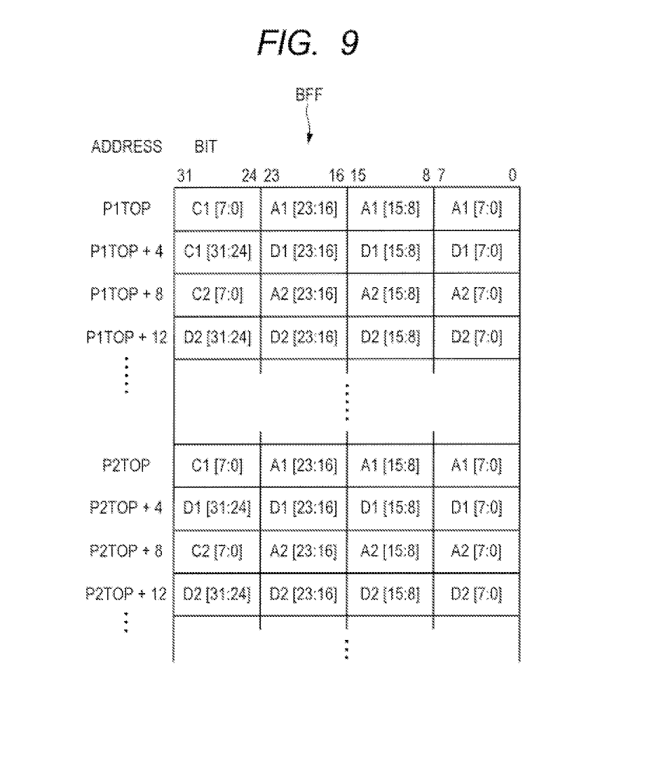

FIG. 9 is an explanatory diagram illustrating an example of the data structure of the buffer BFF provided in the micro controller MCR illustrated in FIG. 8.

The buffer BFF is a memory with a data size of 4 bytes, and configured with a volatile semiconductor memory such as an SRAM, as is the case with the buffer BFF illustrated in FIG. 1. Bits 31-24 are a command and bits 23-0 are an address, or bits 31-0 are data.

Two continuous pieces of 4-byte data serve as a piece of access information per access. The buffer access generates 4 bytes of read access or write access twice per one access to the peripheral circuit.

The address of the buffer BFF is expressed in units of a byte, and “P1TOP” is the starting address for the program PGM-1 and corresponds to the command and the address, and “P1TOP+4” is the starting address for the program PGM-1 and corresponds to the data.

“P2TOP” is the starting address for the program PGM-2 and corresponds to the command and the address, and “P2TOP+4” is the starting address for the program PGM-2 and corresponds to the data. The starting address is determined by the central processing unit CPU writing it in the pointer PIT, and the address is incremented by +4 whenever the central processing unit CPU accesses the peripheral circuit and the registration and reference to the buffer BFF is performed.

### An Example of Timing of the First Read Access

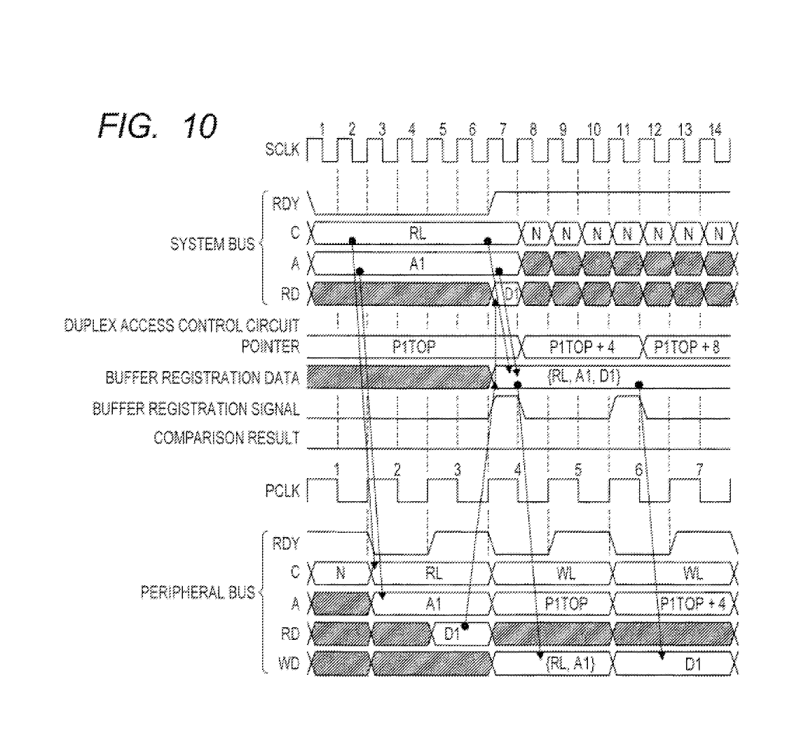

FIG. 10 is a timing chart illustrating an example at the time of a read access to the register provided in the peripheral circuit in the first execution of a program.

FIG. 10 illustrates, beginning at the top, the signal timing in the clock SCLK, the system bus SBS, the duplex access control circuit ACC, the clock PCLK, and the peripheral bus PBS, respectively. FIG. 10 is the same as FIG. 4 in Embodiment 1.

First, at the cycle of the clock SCLK=1, the command C=RL and the address A=A1 (address 1) are outputted to the system bus SBS. The duplex access control circuit ACC sets the ready signal RDY of the system bus SBS to RDY=Lo and keeps a read access waiting.

At the cycle of the clock PCLK=2, the command C=RL and the address A=A1 are outputted to the peripheral bus PBS. At this cycle, since the read data is not read to the read data RD, the ready signal RDY is set as RDY=Lo.

At the cycle of the clock PCLK=3, D1 (data 1) is read from the register of the peripheral circuit assigned to the address of A1, and the ready signal RDY is set as RDY=Hi. At the cycle of the clock SCLK=7, the duplex access control circuit aid outputs D1 outputted to the read data RD of the peripheral bus PBS to the read data RD of the system bus SBS, and sets the ready signal RDY as RDY=Hi, to complete the read access.

Assigning the command C=RL, the address A=A1, and the read data RD=D1 as the buffer registration data, and setting the buffer registration signal to Hi, the data is written at the buffer address=P1TOP indicated by the pointer PIT.

The buffer BFF is coupled to the peripheral bus PBS. Therefore, the data is written in 4 bytes at a time via the peripheral bus PBS. At the cycle of the clock PCLK=4, the buffer address=P1TOP is outputted to the address of the peripheral bus PBS, the command C=RL and the address A=A1 are outputted to the write data WD, and they are written in the buffer BFF.

Next, at the cycle of the clock PCLK=6, the buffer address=P1TOP+4 is outputted to the address of the peripheral bus PBS, the data D1 is outputted to the write data, and they are written in the buffer BFF.

Hereafter, when the read access to the register of the peripheral circuit occurs, the access to the peripheral bus PBS and the buffer registration of the access information are performed in the same manner.

### An Example of Timing of the Second Read Access

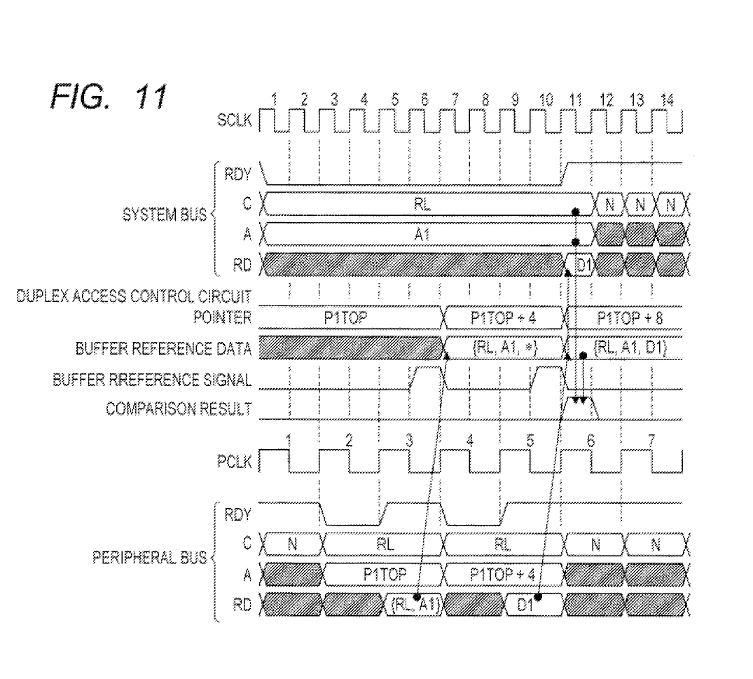

FIG. 11 is a timing chart illustrating an example at the time of a read access to the register provided in the peripheral circuit in the second execution of the program.

As is the case with FIG. 10, FIG. 11 illustrates, beginning at the top, the signal timing in the clock SCLK, the system bus SBS, the duplex access control circuit ACC, the clock PCLK, and the peripheral bus PBS, respectively.

Put the cycle of the clock SCLK=1, the command C=RL and the address A=A1 are outputted to the system bus SBS. The duplex access control circuit ACC sets the ready signal RDY of the system bus SBS to RDY=Lo and keeps a read access waiting.

At the cycle of the clock PCLK=2, the buffer address=P1TOP is outputted to the address of the peripheral bus PBS, and a read from the buffer BFF is performed. The buffer reference data is set as {RL, A1} at the cycle of the clock PCLK=4.

On the other hand, the pointer PIT is incremented by 4 bytes and updated to the value (P1TOP+4). At the same cycle, the buffer address=P1TOP+4 is outputted to the address of the peripheral bus PBS, and a read from the buffer is performed. At the cycle of the clock PCLK=6, the read data RD=D1 is added to the buffer reference data, setting it as {RL, A1, D1}. The read data RD=D1 is outputted to the system bus SBS, and the ready signal RDY is set as RDY=Hi, to complete the read access.

Here, the command C and address A of the system bus SBS are compared with the buffer reference data. In the case of agreement, the signal SG450 expressing the comparison result is set to Lo, and in the case of disagreement, the signal SG450 expressing the comparison result is set to Hi. On the other hand, the pointer PIT is incremented by 4 bytes and updated to the value (P1TOP+8).

Hereafter, when the read access to the register of the peripheral circuit occurs, the buffer reference and comparison of the access information are performed in the same manner.

### An Example of Timing of the First Write Access

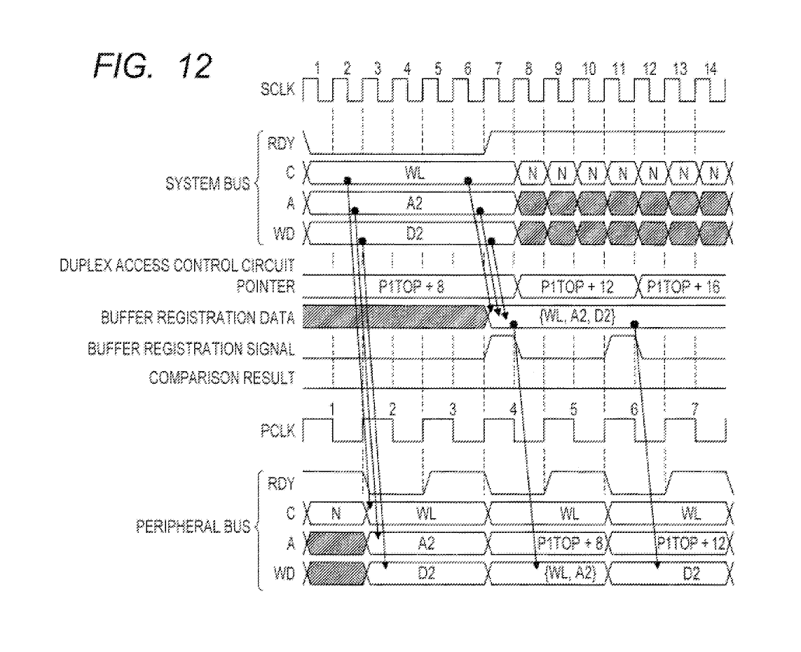

FIG. 12 is a timing chart illustrating an example at the time of a write access to the register provided in the peripheral circuit in the first execution of the program.

As is the case with FIG. 4, FIG. 12 illustrates, beginning at the top, the signal timing in the clock SCLK, the system bus SBS, the duplex access control circuit ACC, the clock PCLK, and the peripheral bus PBS, respectively. What is different from FIG. 10 is the point that the read data RD in the system bus SBS is transcribed as the write data WD.

First, at the cycle of the clock SCLK=1, the command C=WL, the address A=A2 (address 2), and the write data WD=D2 (data 2) are outputted to the system bus SBS.

The duplex access control circuit ACC sets the ready signal RDY of the system bus SBS to RDY=Lo and keeps a write access waiting. At the cycle of the clock PCLK=2, the command C=WL, the address A=A2, and the write data WD=D2 are outputted to the peripheral bus PBS. At this cycle, since the write access cannot be completed, the ready signal RDY is set as RDY=Lo.

At the cycle of the clock PCLK=3, the write data WD=D2 is written in the register of the peripheral circuit assigned to the address A=A2, and the ready signal RDY is set as RDY=Hi.

At the cycle of the clock SCLK=7, the duplex access control circuit ACC sets the ready signal RDY as RDY=Hi, to complete the write access. Assigning the command C=WL, the address A=A2, and the write data WD=D2 as the buffer registration data, and setting the buffer registration signal to Hi, the data is written at the buffer address=P1TOP+8 indicated by the pointer PIT.

The buffer BFF is coupled to the peripheral bus PBS, accordingly, the data is written in 4 bytes at a time via the peripheral bus PBS. At the cycle of the clock PCLK=4, the buffer address=P1TOP+8 is outputted to the address of the peripheral bus PBS, the command C=WL and the address A=A2 are outputted to the write data WD, and they are written in the buffer.

Next, At the eyed e of the clock PCLK=6, the buffer address=P1TOP+12 is outputted to the address of the peripheral bus PBS, the data D2 is outputted to the write data WD, and they are written in the buffer BFF.

Hereafter, when the write access to the register of the peripheral circuit occurs, the access to the peripheral bus PBS and the buffer registration of the access information are performed in the same manner.

### An Example of Timing of the First Write Recess

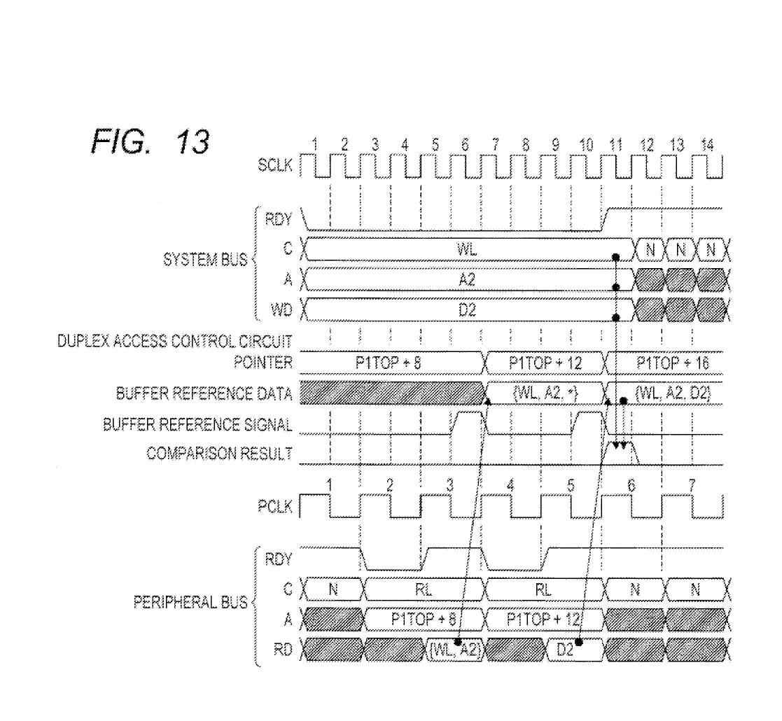

FIG. 13 is a timing chart illustrating an example at the time of a write access to the register provided in the peripheral circuit in the second execution of the program.

As is the case with FIG. 12, FIG. 13 illustrates, beginning at the top, the signal timing in the clock SCLK, the system bus SBS, the duplex access control circuit ACC, the clock PCLK, and the peripheral bus PBS, respectively.

First, at the cycle of the clock SCLK=1, the command C=WL, the address A=A2, and the write data WD=D2 are outputted to the system bus SBS. The duplex access control circuit ACC sets the ready signal RDY of the system bus SBS to RDY=Lo and keeps a write access waiting.

At the cycle of the clock PCLK=2, the buffer address=P1TOP+8 is outputted to the address of the peripheral bus PBS, and a read from the buffer BFF is performed. The buffer reference data is set as {WL, A2} at the cycle of the clock PCLK=4.

On the other hand, the pointer PIT is incremented by 4 bytes and updated to the value (P1TOP+12). At the same cycle, the buffer address=P1TOP+12 is outputted to the address of the peripheral bus PBS, and a read from the buffer BFF is performed. At the cycle of the clock PCLK=6, the write data WD=D2 is added to the buffer reference data, setting it as {WL, A2, D2}.

The ready signal RDY of the system bus SBS is set as RDY=Hi, to complete the write access. Here, the command C, address A, and write data WD of the system bus SBS are compared with the buffer reference data. In the case of agreement, the signal SG450 expressing the comparison result is set to Lo, and in the case of disagreement, the signal SG450 expressing the comparison result is set to Hi. On the other hand, the pointer PIT is incremented by 4 bytes and updated to the value (P1TOP+16).

Hereafter, when the write access to the register of the peripheral circuit occurs, the buffer reference and comparison of the access information are performed in the same manner.

Also by the configuration described above, it is possible to reduce the increase in the development man-hour of the program, and it is possible to realize the micro controller MCR at low cost. It is also possible to realize reduction in the power consumption and reduction in size of the micro controller MCR.

### Embodiment 3

### A Configuration Example and an Operation Example of the Micro Controller

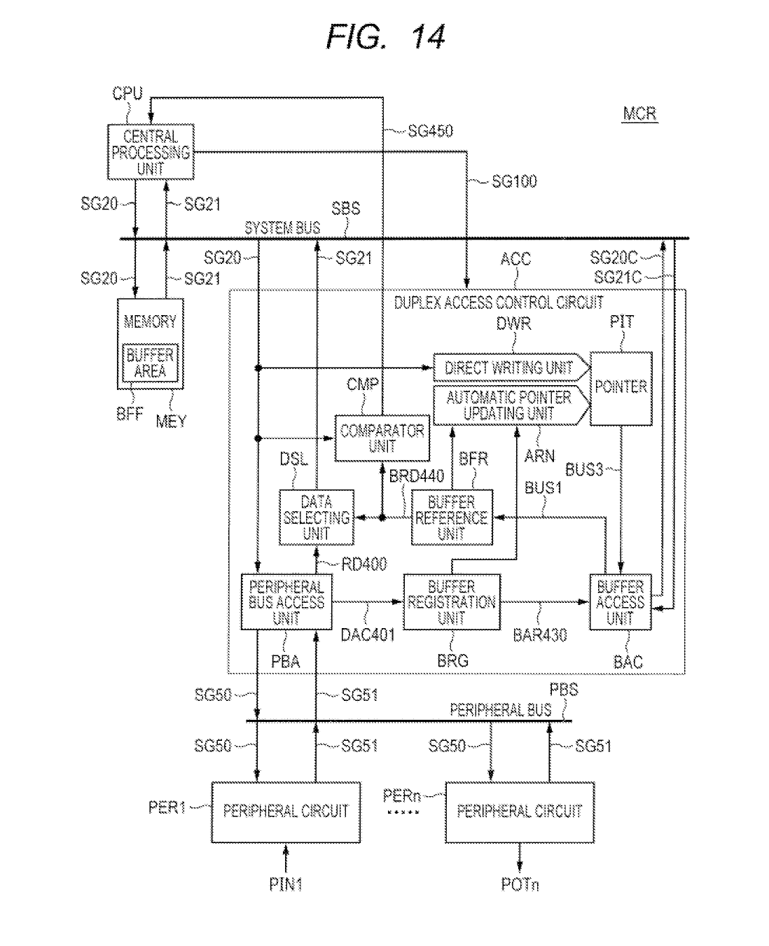

FIG. 14 is a block diagram illustrating an example of a configuration of a micro controller MCR according to Embodiment 3.

In the configuration illustrated in FIG. 8 according to Embodiment 2, the buffer BFF to which the access information is registered is coupled to the peripheral bus PBS; however, in the micro controller MCR illustrated in FIG. 14, the buffer BFF is provided in the memory MEY coupled to the system bus SBS. The other parts of the configuration are the same as those of the configuration illustrated in FIG. 8 according to Embodiment 2.

Here, the buffer BFF provided in the memory MEY is a volatile semiconductor memory such as an SRAM. In the memory MEY, the storage area for storing instruction to be executed by the central processing unit CPU and the data to be processed is a nonvolatile semiconductor memory such as a flash memory, for example.

In this way, by using a part of the memory MEY as the buffer BFF, a new buffer is not necessary and it is possible to reduce the cost.

The peripheral bus access unit PBA monitors a signal SG20 of the system bus SBS, and accesses the peripheral bus PBS. When the signal SG20 indicates a read or a write, and when the signal SG100 expressing the count of the duplex processing indicates the first execution, the peripheral bus access unit PBA accesses the peripheral bus PBS.

When the signal SG20 indicates a read, the read data RD400 read by the peripheral bus access unit PBA is selected by the data selecting unit DSL, outputted to the system bus SBS, and fetched to the central processing unit CPU.

The peripheral bus access unit PBA outputs the access information DAC401 (command, address, data (read data in the case of read, and write data in the case of write)), and the buffer registration unit BRG outputs a buffer access request signal BAR430 to the buffer access unit BAC.

The buffer access unit BAC outputs a signal SG20C serving as an access signal to the system bus SBS, and a write is performed to the buffer BFF prodded in the memory MEY.

As is the case with the buffer BFF illustrated in FIG. 1 according to Embodiment 1, the buffer BFF has the divided buffer areas for use in each program, such as, an area for the program PGM-1, an area for the program PGM-2, . . . , and an area for the program PGM-m (not shown).

When the signal SG20 indicates a read or a write, and when the signal SG100 indicates the second processing, the peripheral bus PBS is not accessed. In order to read the access information registered in the buffer BFF provided in the Memory MEY in the first execution by the buffer reference unit BRF, the buffer access unit BAC outputs the signal SG20C serving as an access signal to the system bus SBS, and performs a read.

The access information read is outputted from the buffer access unit BAC to the buffer reference unit BRF. In the case of a read, read data is selected by the data selecting unit DSL, outputted to the system bus SBS, and fetched to the central processing unit CPU.

The comparator unit CMP compares the signal SG20 as the access information (command, address, write data in the case of a write) with the buffer reference data BRD440.

The pointer PIT assigns the address at which registration and reference to the buffer BFF are performed. The pointer PIT is provided as a dedicated register of the duplex access control circuit ACC. When the central processing unit CPU controls the direct writing unit DWR immediately after the processing of a program starts, the value of this dedicated register is written directly. The pointer PIT is updated automatically by the automatic pointer updating unit ARN after the registration and reference to the buffer BFF are performed.

Also by the configuration described above, it is possible to reduce the increase in the development man-hour of the program, and it is possible to realize the micro controller MCR at low cost. It is also possible to realize reduction in the power consumption and reduction in size of the micro controller MCR.

### Embodiment 4

### A Configuration Example of a Micro Controller

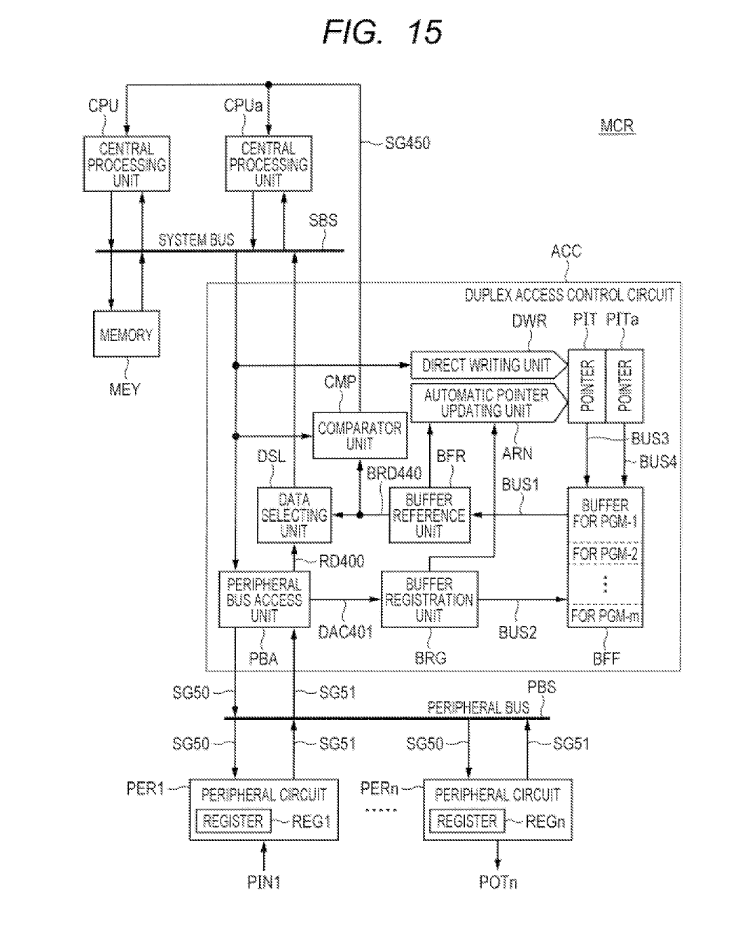

FIG. 15 is a block diagram illustrating an example of a configuration of a micro controller MCR according to Embodiment 4.

In Embodiment 4, the explanation is made for the case where a duplex access control circuit is provided in a micro controller which performs parallel processing of a program by a dual-core CPU instead of a single-core CPU.

The micro controller MCR is a dual-core CPU configuration provided with two central processing units CPU and CPUa, as illustrated in FIG. 15. The central processing unit CPU and the central processing unit CPUa are coupled to the system bus SBS, respectively.

The central processing unit CPU as the first central processing unit and the central processing unit CPUa as the second central processing unit can perform respectively independent processing and can perform parallel processing of the same program as well. The duplex access control circuit ACC is provided with two pointers PIT and PITa.

The buffer BFF is coupled to the buffer reference unit BRF via a dedicated bus BUS1, and to the buffer registration unit BRG via a dedicated bus BUS2. The buffer BFF is also coupled to the pointer PIT as the first pointer via a dedicated bus BUS3, and to the pointer PITa as the second pointer via a dedicated bus BUS4. By the present configuration, it is possible to improve the speed of write, reference, etc. of the access information to the buffer BFF. The other parts of the configuration are the same as those of the configuration illustrated in FIG. 1 according to Embodiment 1.

### An Operation Example of the Micro Controller

When the central processing unit CPU or the central processing unit CPUa accesses the registers REG1-REGn built in the peripheral circuits PER1-PERn, the duplex access control circuit ACC accesses a register of one of the peripheral circuits PER1-PERn, in the first execution of the program processing.

Then, the duplex access control circuit ACC registers the access information to the buffer BFF. In the second execution of the program processing, the duplex access control circuit ACC does not access to a register of any one of the peripheral circuits PER1-PERn, but compares the access information with the first information registered to the buffer BFF, by means of the comparator unit CMP, and detects a fault if any.

In the case of the dual-core CPU configuration, there is no way to identify which of the central processing unit CPU and the central processing unit CPUa accesses a register of the peripheral circuit first. That is, it is difficult to adopt the method of setting the count of the duplex processing with the use of the register provided in the central processing unit, as in Embodiment 1-Embodiment 3.

Therefore, the duplex access control circuit ACC is configured with two independent pointers indicating the buffer address: the pointer PIT used by the central processing unit CPU and the pointer PITa used by the central processing unit CPUa.

Including a signal for identifying the central processing unit which has accessed the system bus SBS, the duplex access control circuit ACC uses the pointers respectively corresponding to the central processing units CPU and CPUa.

The values of the pointer PIT and the pointer PITa are compared. When the vales of one of the pointers is equal or greater, the access corresponding to the pointer can be considered to be an anterior access. When the value of the pointer is smaller, the access corresponding to the pointer can be considered to be a posterior access. The other operations are the same as those in Embodiment 1.

### An Example of Timing of an Anterior Read Access

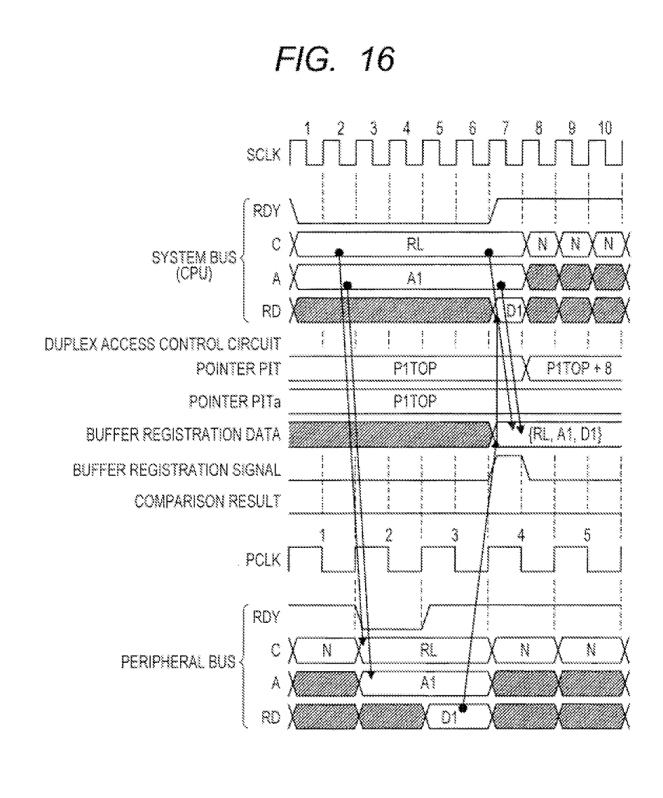

FIG. 16 is a timing chart illustrating an example at the time of an anterior read access to a register provided in the peripheral circuit in the parallel processing of a program.

As is the case with FIG. 4 according to Embodiment 1, FIG. 16 illustrates, beginning at the top, the signal timing in the clock SCLK, the system bus SBS, the duplex access control circuit ACC, the clock PCLK, and the peripheral bus PBS, respectively. FIG. 16 is different from FIG. 4 in the point that the signal timing of the pointer PITa is newly added in the duplex access control circuit ACC.

First, at the cycle of the clock SCLK=1, the central processing unit CPU outputs a command C=RL and an address A=A1 (address 1) to the system bus SBS. Since the pointer PIT=the pointer PITa, the current access can be considered as an anterior access. The duplex access control circuit ACC sets the ready signal RDY of the system bus SBS to RDY=Lo and keeps a read access waiting.

At the cycle of the clock PCLK=2, the command C=RL and the address A=A1 are outputted to the peripheral bus PBS. At this cycle, since the read data is not read to the read data RD, the ready signal RDY is set as RDY=Lo.

At the cycle of the clock PCLK=2, the read data RD=D1 (data 1) is read from the register of the peripheral circuit assigned to the address A=A1, and the ready signal RDY is set as RDY=Hi.

At the cycle of the clock SCLK=7, the duplex access control circuit ACC outputs D1 outputted to the read data RD of the peripheral bus PBS, to the read data RD of the system bus SBS, and the ready signal RDY is set as RDY=Hi, to complete the read access.

Assigning the command C=RL, the address A=A1, and the read data RD=D1 as the buffer registration data, and setting the buffer registration signal to Hi, the data is written at the buffer address=P1TOP indicated by the pointer PIT, then the pointer PIT is incremented by 8 bytes and updated to the value (P1TOP+8).

### An Example of Timing of a Posterior Read Access

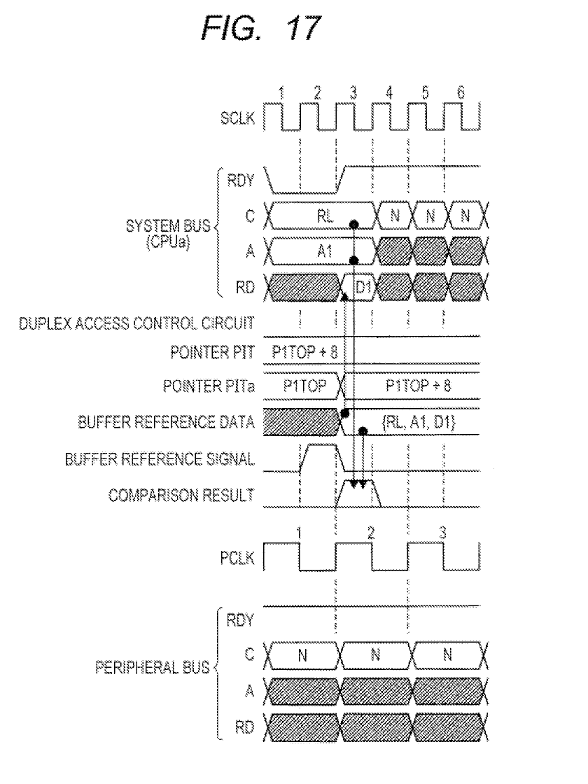

FIG. 17 is a timing chart illustrating an example at the time of a posterior read access to the register provided in the peripheral circuit in the parallel processing of the program.

First, at the cycle of the clock SCLK=1, the central processing unit CPUa outputs a command C=RL and an address A=A1 to the system bus SBS. Since the pointer PIT>the pointer PITa, the current access can be considered as a posterior access. The duplex access control circuit ACC sets the ready signal RDY of the system bus SBS to RDY=Lo and keeps a read access waiting.

At the cycle of the clock SCLK=2, setting the buffer reference signal to Hi, the data is read from the buffer address=P1TOP indicated by the pointer PITa. The buffer reference data is set as {RL, A1, D1} at the cycle of the clock SCLK=3.

D1 is outputted to the read data RD of the system bus SBS, and the ready signal RDY is set as RDY=Hi, to complete the read access. Here, the command C and address A of the system bus SBS are compared with the buffer reference data.

In the case of agreement, the signal SG450 expressing the comparison result is set to Lo, and in the case of disagreement, the signal SG450 expressing the comparison result is set to Hi. On the other hand, the pointer if PITa is incremented by 8 bytes and updated to the value (P1TOP+8).

### An Example of Timing of an Anterior Write Access

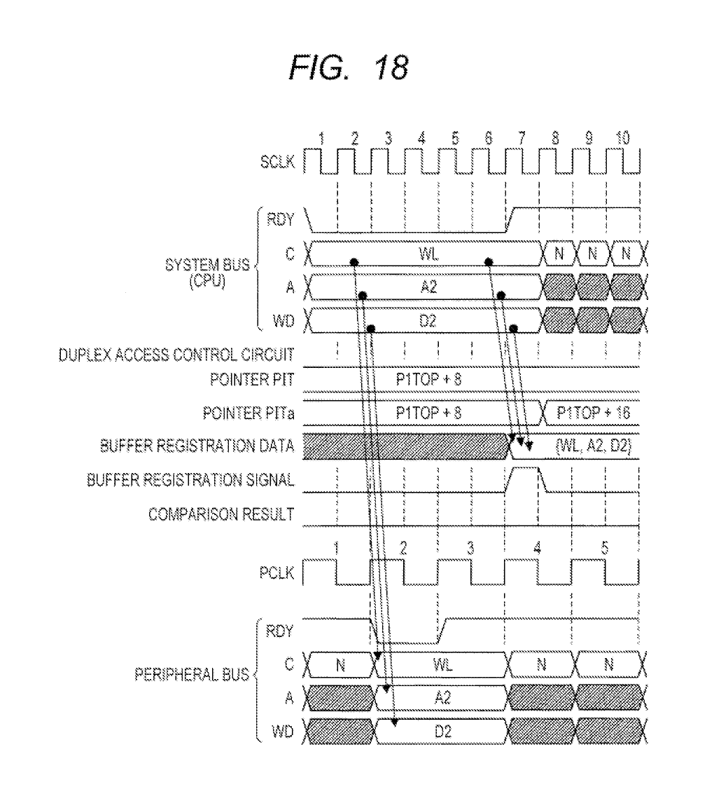

FIG. 18 is a timing chart illustrating an example at the time of an anterior write access to the register provided in the peripheral circuit in the parallel processing of the program.

First, at the cycle of the clock SCLK=1, the central processing unit CPUa outputs the command C=WL, the address A=A2 (address 2), and the write data WD=D2 (data 2) to the system bus SBS.

Since the pointer PIT=the pointer PITa, the current access can be considered as an anterior access. The duplex access control circuit ACC sets the ready signal RDY of the system bus SBS to RDY=Lo and keeps a write access waiting.

At the cycle of the clock PCLK=2, the command C=WL, the address A=A2, and the write data WD=D2 are outputted to the peripheral bus PBS. At this cycle, since the write access cannot be completed, the ready signal RDY is set as RDY=Lo.

At the cycle of the clock PCLK=3, the write data WD=D2 is written in the register of the peripheral circuit assigned to the address A=A2, and the ready signal RDY is set as RDY=Hi. At the cycle of the clock SCLK=7, the duplex access control circuit ACC sets the ready signal RDY as RDY=Hi, to complete the write access.

Assigning the command C=WL, the address A=A2, and the write data WD=D2 as the buffer registration data, and setting the buffer registration signal to Hi, the data is written at the buffer address=P1TOP+8 indicated by the pointer PITa, then the pointer PITa is incremented by 8 bytes and updated to the value (P1TOP+16).

### An Example of Timing of a Posterior Write Access

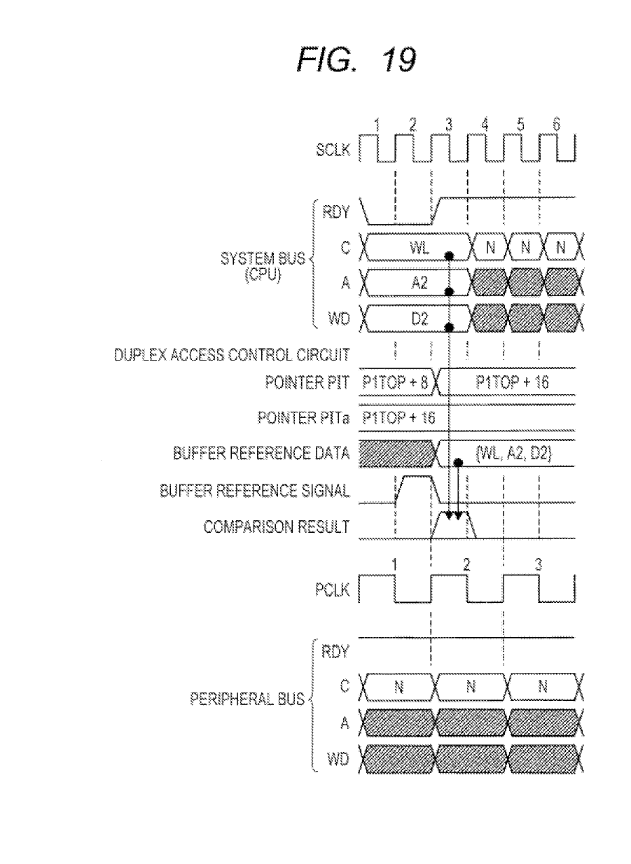

FIG. 19 is a timing chart illustrating an example at the time of a posterior write access to the register provided in the peripheral circuit in the parallel processing of the program.

At the cycle of the clock SCLK=1, the central processing unit CPU outputs the command C=WL, the address A=A2, and the write data WD=D2 to the system bus SBS. Since the pointer PIT<the pointer PITa, the current access can be considered as a posterior access. The duplex access control circuit ACC sets the ready signal RDY of the system bus SBS to RDY=Lo and keeps a write access waiting.

At the cycle of the clock SCLK=2, setting the buffer reference signal to Hi, the data is read from the buffer address=P1TOP+8 indicated by the pointer PIT, and the buffer reference data is set as {WL, A2, D2} at the cycle of the clock SCLK=3.

The ready signal RDY of the system bus SBS is set as RDY=Hi, to complete the write access. Here, the command C, address A, and write data WD of the system bus SBS are compared with the buffer reference data.

In the case of agreement, the signal SG450 expressing the comparison result is set to Lo, and in the case of disagreement, the signal SG450 expressing the comparison result is set to Hi. On the other hand, the pointer PIT is incremented by 8 bytes and updated to the value (P1TOP+16).

By the configuration described above, it is possible to improve the processing speed in the micro controller MCR, and at the same time, it is possible to realize the reduction in the cost, the power consumption, and the size.

### Embodiment 5

### An Example of Application to a System

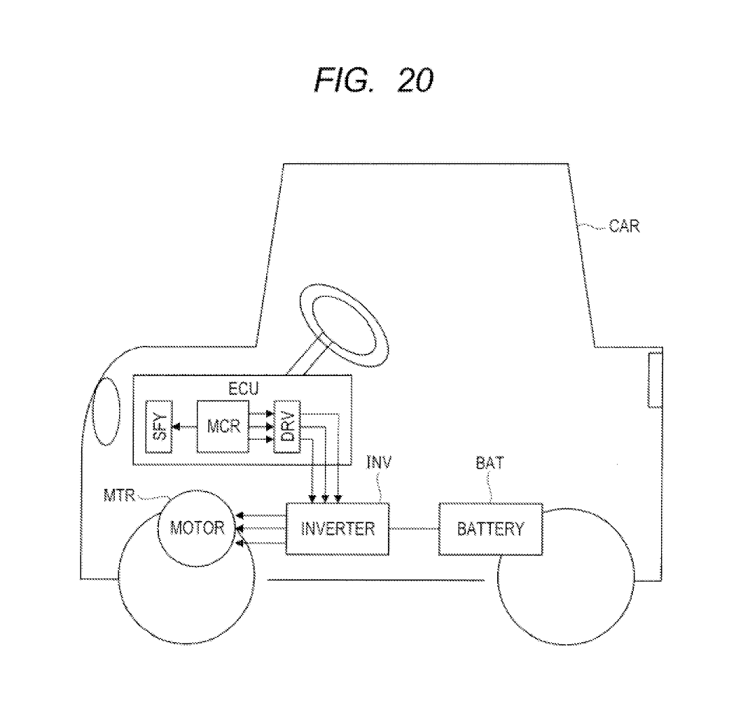

FIG. 20 is an explanatory diagram illustrating an example of a system using a micro controller according to Embodiment 5.

FIG. 20 illustrates an automobile CAR as the example of a system, in which the micro controller MCR is mounted in an electronic control unit ECU for controlling actuators, such as a motor MTR.

As illustrated in FIG. 20, on electronic control unit ECU, a motor MTR, an inverter INV, and a battery BAT are mounted in the automobile CAR. The inverter INV is coupled to the electronic control unit ECU.

The motor MTR and the battery BAT are coupled to the inverter INV, respectively. The inverter INV generates a driving power supply voltage for driving the motor MTR from a power supply voltage supplied from the battery BAT, on the basis of a control signal outputted from the electronic control unit ECU. The motor MTR operates on the basis of the driving power supply voltage generated by the inverter INV.

The electronic control unit ECU is configured with a safety device SFY, the micro controller MCR, and a driver DRV. The control signal outputted from the micro controller MCR is amplified by the driver DRV. The driver DRV makes the inverter INV drive the motor MTR on the basis of the inputted control signal.

The safety device SFY is coupled so as to input the signal SG450 illustrated in FIG. 1. When the safety device SFY receives the signal SG450 outputted when the duplex access control circuit ACC of the micro controller MCR detects the abnormalities of the central processing unit CPU, the safety function operates.

Although the design of the safety function in the safety device SFY depends on the system, it can be considered that an alarm indicating the fault is displayed on a dashboard or the automobile CAR, for example. Alternatively, it can be considered that the control of the motor MTR by the micro controller MCR is stopped.

It can be also considered that the electronic control unit ECU is configured with the duplexed micro controllers MCR executing the same processing, and the control signal to be outputted to the driver DRV can be switched.

By the configuration described above, it is possible to guarantee the safety of the system, and at the same time, it is also possible to realize reduction in the cost, the power consumption, and the size of the micro controller MCR.

As described above, the invention accomplished by the present inventors has been concretely explained based on various embodiments. However, it cannot be overemphasized that the present invention is not restricted to the embodiments, and it can be changed variously in the range which does net deviate from the gist.

The present invention is not restricted to the embodiments described above, and can include various modifications and alternations. For example, the embodiments given above are described in detail, in order to explain the present invention plainly, and the present invention is not always restricted to the one provided with all the explained configurations.

It is possible to replace a part of the configuration illustrated in a certain embodiment with the configuration illustrated in another embodiment. It is also possible to add the configuration illustrated in another embodiment to the configuration in the configuration illustrated in a certain embodiment. It is also possible to perform addition, deletion, and substitution of other configurations to a part of the configuration of each embodiment.

What is claimed is:

1. A semiconductor integrated circuit device comprising:
a peripheral circuit provided with a register and operable to execute processing on the basis of a command inputted;
a central processing unit operable to execute duplex processing in which processing by the same program accessing the register is executed twice; and
an access control circuit operable to perform access control when the central processing unit accesses the peripheral circuit,
wherein the access control circuit comprises:
a bus access unit operable to control access to the register by the central processing unit in the first execution of the program by the central processing unit;
an access information storage unit operable to store first access information which is the information at the time of the central processing unit accessing the register in the first execution of the program by the central processing unit; and
a comparator unit operable to compare the first access information stored in the access information storage unit, with second access information which is the information at the time of the central processing unit accessing the register in the second execution of the program by the central processing unit, and operable to output an error signal to the central processing unit when the first access information disagrees with the second access information.

2. The semiconductor integrated circuit device according to claim 1,
wherein, when the error signal outputted by the comparator unit is inputted, the central processing unit determines that abnormalities hare occurred in the execution of processing by the program and executes an exception handling program.

3. The semiconductor integrated circuit device according to claim 1,
wherein the central processing unit outputs a processing count determination signal for determining whether the execution count of the program is the first count or the second count, and
wherein the bus access unit determines whether the execution count of the program is the first count or the second count, on the basis of the processing count determination signal outputted from the central processing unit.

4. The semiconductor integrated circuit device according to claim 1,
wherein the access control circuit further comprises:
a pointer operable to indicate an address to be used in registration and reference of the first access information to the access information storage unit; and
an automatic pointer updating unit operable to update the address automatically whenever registration or reference is performed to the access information storage unit, and
wherein the central processing unit sets up a starting address to be registered first in the access information storage unit.

5. The semiconductor integrated circuit device according to claim 4,
wherein the access control circuit comprises:
a registration unit operable to register the first access information in the access information storage unit; and
a reference unit operable to read the first access information stored in the access information storage unit, and operable to output the read first access information to the comparator unit, and
wherein the registration unit and the access information storage unit, the reference unit and the access information storage unit, and the pointer and the access information storage unit are respectively coupled by a dedicated bus.

6. A semiconductor integrated circuit device comprising:
a peripheral circuit coupled to a first bus and provided with a register, and operable to execute processing on the basis of a command inputted;
a central processing unit coupled to a second bus and operable to execute twice the same program accessing the register;
an access information storage unit coupled to the first bus and operable to store first access information which is the information at the time of the central processing unit accessing the register in the first execution of the program by the central processing unit; and
an access control circuit coupled to the first bus and the second bus, respectively, and operable to perform access control at the time of the central processing unit accessing the peripheral circuit,
wherein the access control circuit comprises:
a bus access unit operable to control access to the register by the central processing unit in the first execution of the program by the central processing unit;
a buffer access unit operable to perform access control of the access information storage unit at the time of storing the first access information; and
a comparator unit operable to compare the first access information stored in the access information storage unit, with second access information which is the information at the time of the central processing unit accessing the register in the second execution of the program by the central processing unit, and operable to output an error signal to the central processing unit when the first access information disagrees with the second access information.

7. The semiconductor integrated circuit device according to claim 6,
wherein, when the error signal outputted by the comparator unit is inputted, the central processing unit determines that abnormalities have occurred in the execution of processing by the program and executes an exception handling program.

8. The semiconductor integrated circuit device according to claim 6,
wherein the central processing unit outputs a processing count determination signal for determining whether the execution count of the program is the first count or the second count, and
wherein the bus access unit determines whether the execution count of the program is the first count or the second count, on the basis of the processing count determination signal outputted from the central processing unit.

9. The semiconductor integrated circuit device according to claim 6,
wherein the access control circuit further comprises:
a pointer operable to indicate an address to be used in registration and reference of the first access information to the access information storage unit; and
an automatic pointer updating unit operable to update the address automatically whenever registration or reference is performed to the access information storage unit, and
wherein the central processing unit sets up a starting address to be first registered in the access information storage unit.

10. The semiconductor integrated circuit device according to claim 6,
wherein the access information storage unit is coupled to the second bus, and provided with a region for storing the program to be executed by the central processing unit.

11. A semiconductor integrated circuit device comprising:
a peripheral circuit provided with a register and operable to execute processing on the basis of a command inputted;
a first central processing unit operable to execute processing by a program accessing the register;
a second central processing unit operable to execute processing by the same program as the program executed by the first central processing unit accessing the register;
an access control circuit operable to performs access control at the time of the first central processing unit and the second central processing unit accessing the peripheral circuit,
wherein the access control circuit comprises:
a bus access unit operable to control access to the register by the first central processing unit and the second central processing unit in the first execution of the program by the first central processing unit or the second central processing unit;
an access information storage unit operable to store first access information which is the information at the time of either the first central processing unit or the second central processing unit accessing the register in the first execution of the program by the first central processing unit or the second central processing unit; and
a comparator unit operable to compare the first access information stored in the access information storage unit, with second access information which is the information at the more of either the first central processing unit or the second central processing unit accessing the register in the second execution of the program by the first central processing unit or the second central processing unit, and operable to output an error signal to the first central processing unit and the second central processing unit, respectively, when the first access information disagrees with the second access information.

12. The semiconductor integrated circuit device according to claim 11,
wherein, when the error signal outputted by the comparator unit is inputted, the first central processing unit and the second central processing unit determine that abnormalities have occurred in the execution of processing by the program and execute an exception handling program.

13. The semiconductor integrated circuit device according to claim 11,
wherein the first central processing unit and the second central processing unit output respectively a processing count determination signal for determining whether the execution count of the program is the first count or the second count, and
wherein the bus access unit determines whether the execution count of the program is the first count or the second count, respectively on the basis of the processing count determination signal outputted from the first central processing unit and the second central processing unit.

14. The semiconductor integrated circuit device according to claim 11,
wherein the access control circuit further comprises:
a first pointer operable to indicate an address to be used in registration and reference of the first access information which is the information at the time of the first central processing unit accessing the register in the first execution of the program by the first central processing unit;
a second pointer operable to indicate an address to be used in registration and reference of the first access information which is the information at the time of the second central processing unit accessing the register in the first execution of the program by the second central processing unit;
a first automatic pointer updating unit operable to update the address of the first pointer automatically whenever registration or reference is performed to the access information storage unit;
a second automatic pointer updating unit operable to update the address of the second pointer automatically whenever registration or reference is performed to the access information storage unit, and
wherein the first central processing unit and the second central processing unit set up, respectively, a starting address to be first registered in the access information storage unit.
